(19) United States
(12) Patent Application Publication
(10) Pub. No.: US 2012/0234471 A1
(43) Pub. Date: Sep. 20, 2012

(54) DECORATIVE COATING, WITH BUILT-IN ADHESIVE, FOR A TRANSPORT VEHICLE

(76) Inventor: Thierry Guenard, Romilly Sur Seine (FR)

(21) Appl. No.: 13/497,502

(22) PCT Filed: Sep. 17, 2010
(86) PCT No.: PCT/FR2010/051934

§ 371 Date: May 22, 2012

(30) Foreign Application Priority Data
Sep. 22, 2009 (FR) 0956529

(51) Int. Cl. B32B 3/18; B32B 38/14

(52) U.S. Cl. 156/182; 428/201; 428/203

(57) ABSTRACT

The present disclosure relates to a decorative coating to be applied onto an outer surface of a transport vehicle, said coating including a decorative adhesive that is consecutively made up a bottom adhesive layer, a layer for mechanically mounting the adhesive, and an illustrated layer comprising at least one printed pattern, the adhesive being applied onto the outer surface of the vehicle. Said coating also includes a colored paint layer that is applied onto the outer surface of the vehicle outside the surface covered by the adhesive being continuous. Said coating moreover includes a protective layer that is applied onto the continuous outer surfaces of the paint layer and the adhesive. The present disclosure also relates to a decoration method and to a decoration renewing method.

### CROSS-REFERENCE TO RELATED APPLICATIONS

This is a national phase application under 35 U.S.C. §371 of PCT Application No. PCT/FR2010/051934 filed Sep. 17, 2010, which claims the benefit of French application No. 0956529 filed Sep. 22, 2009, the contents of each of which are expressly incorporated herein by reference.

### FIELD OF ART

The present disclosure relates to the field of decorating transport vehicles, in particular, railway transport vehicles.

### BACKGROUND

Decorating railway vehicles fills an essentially aesthetic function. This allows to personalize vehicles and to make them more pleasant to look at, more attractive. Decorating railway vehicles also fills a protection function for the external surface of vehicles against external aggressions (rain, hail, graffiti, etc.).

FIGS. 1-3 illustrate a prior art railway vehicle. With reference to FIG. 1, which is a sectional view, before a railway vehicle is put into service, the latter is traditionally decorated with paint, according to a conventional method wherein there are applied successively on the external surface 1 of the vehicle:

an undercoat 1 of a low thickness of approximately 50 micrometres (traditionally in a white colour,

a coloured base coat 12 of a thickness being lower than 25 μm the colour of which is free, and

a varnish coat 13 of a thickness of approximately 50 μm for protecting the base coat 12 against external aggressions, such a varnish being generally transparent.

Such a paint application method allows large surfaces to be efficiently decorated on a smooth or nearly smooth way (colour scales) with a coating of a low thickness (150 to 200 μm). Unfortunately, such a method does not allow the vehicle to be decorated with patterns having various shapes and colours. It is in particular not possible to decorate the vehicle with digital drawings or photographs.

In order to overcome such a drawback, adhesives are known comprising a pattern to be applied on the external surface of the vehicle, the pattern of the adhesive being freely selected. Any drawing or photograph type could be reproduced on an adhesive through digital printing or screen printing.

Such adhesives 20 (FIG. 2) are commonly sold on the market and successively comprise several coats. With reference to FIG. 2, the adhesive comprises from the lower coat to the upper coat thereof:

a lower protective film 21,

a lower glue coat 22,

a mechanical support 23,

an ink coat 24 comprising at least one pattern,

an upper glue coat 25,

a final external protective film 26 consisting of a varnish. PVC or polyester, and

an upper protective film 27.

In order to fix the adhesive 20 on the external surface 1 of the vehicle, with reference to FIG. 3, the lower 21 and upper 27 protective films are removed and the lower glue coat 22 is brought into contact with the external surface of the vehicle 1, the surface of the vehicle 1 having been preliminarily covered with a paint coat 11, subsequently referred to as an undercoat. The adhesive could also be applied on a paint coat, either protected or not by a varnish coat, preliminarily applied on the vehicle.

The adhesive 20, being applied on the external surface 1 of the vehicle, is thus in relief with respect to the paint undercoat 11. Due to such a relief the thickness of the adhesive, in the order of 200 micrometres, is exposed to wind while the vehicle is moving, resulting in the adhesive being prematurely damaged, the life duration thereof not exceeding 7 years, whereas a paint one exceeds 12 years.

Moreover, the adhesive 20 tends to <<peel>> due to the upper glue coat 25 and the upper film coat 26 being damaged: this is then referred to as delaminated adhesive coats. Delamination is enhanced by the traffic speed of the railway vehicle exceeding 300 km/hr. A delaminated adhesive enhances the corrosion of the vehicle, as rain water is able to come into contact with the external surface of the vehicle.

The damaged adhesive 20 has an unaesthetic appearance and it is necessary to replace it. For performing such an operation, the vehicle must standstill, which is a drawback.

In addition to their reduced life duration, current adhesives are difficult to remove and it is necessary to make use of chemicals that should be handled with care, lengthening the standstill duration of the vehicle and the resulting drawbacks in terms of profitability and cost.

### SUMMARY

In order to overcome such drawbacks, the present method, system and device relate to a decorative coating being able to be applied on an external surface of a transport vehicle, comprising:

a decorative adhesive successively consisting of a lower glue coat, a mechanical support coat for the adhesive and an illustrated coat comprising at least one printed pattern, the adhesive being applied on the external surface of the vehicle;

a coloured paint coat applied on the external surface of the vehicle outside the surface covered by the adhesive, the external surfaces of the paint coat and the adhesive being continuous, and

a protective coat applied on the continuous external surfaces of the paint coat and the adhesive.

Thanks to the present method, system and device, there is provided an aesthetic coating, with a long life duration, the adhesive being laterally protected by the paint coat and, at the exterior, by the protective coat. This is referred to as a coating with an integrated adhesive.

Preferably, the paint coat has the same thickness as the adhesive.

Preferably, the adhesive has a thickness ranging between 20 and 40 micrometres for integrating it into a paint coat without creating any over-thickness in the coating, or relief. This is advantageously achieved by reducing the thickness of the mechanical support coat for the adhesive, all the elements of the coating being involved in the support of the illustrated coat, in particular, the paint coat and the protective coat.

Preferably, the coating has a thickness ranging between 50 and 80 micrometres, more preferably 70 micrometres. This advantageously allows the vehicle to be decorated satisfactorily without increasing the vehicle mass with a thick, and thus, heavy coating.

Advantageously, a paint undercoat is applied between the external surface of the vehicle, on the one hand, and the decorative adhesive and the paint coat, on the other hand.

Preferably, the mechanical support coat for the adhesive comprises a paint film in a dry state. Such a support is simple to be implemented and allows the compatibility to be enhanced with the varnish coat and the paint coat applied on the external surface of the vehicle outside the surface covered by the adhesive. Still preferably, the mechanical support coat for the adhesive comprises a paint film in a dry state.

Further preferably, the paint film in a dry state is formed from a paint possessing the same properties as the paint of the coloured paint coat. Using paints of the same nature, the compatibility of the support coat with the varnish coat and the paint coat is enhanced thereby improving the wearing resistance of the coating as well as the ageing resistance thereof.

The present disclosure also relates to a method for decorating an external surface of a transport vehicle, wherein:

a decorative adhesive is applied on the external surface of the vehicle, the adhesive successively consisting of a lower glue coat, a mechanical support coat for the adhesive and an illustrated coat comprising at least one printed pattern;

a coloured paint coat is applied on said external surface of the vehicle outside the surface being covered by the adhesive, the external surfaces of the paint coat and the adhesive being continuous, and

a protective coat is applied on the continuous external surfaces of the paint coat and the adhesive.

A decorative coating is obtained, having a high quality and a long life duration. Moreover, the method for getting it only requires a limited number of steps being simple to be implemented.

Preferably, a paint coat is applied on the external surface of the vehicle preliminarily to the application of the decorative adhesive, free-standing spaces being arranged in the paint coat for receiving the decorative adhesive. This advantageously allows the adhesive to be laid in the free-standing spaces arranged in the paint coat, facilitating the positioning of the adhesive.

Still preferably, a paint undercoat is applied on the external surface of the vehicle preliminarily to the application of the paint coat and the adhesive.

Further preferably, for replacing an old coating with a new coating:

the protective coat of the old coating is partially or completely removed, the thickness of the old coating being constant after removal,

a new decorative adhesive is applied on the external surface of the old coating, the adhesive successively consisting of a lower glue coat, a mechanical support coat for the adhesive and an illustrated coat comprising at least one new printed pattern;

a new coloured paint coat is applied on said external surface of the old coating outside the surface covered by the new adhesive, the external surfaces of the new paint coat and the new adhesive being continuous, and

a new protective coat is applied on the continuous external surfaces of the new paint coat and the new adhesive.

Such a partial removal of the old coating could avoid using toxic products. The protective coat is advantageously removed through sanding. The new coating is applied in good conditions by virtue of the continuity of the surfaces of the old adhesive and the old paint coat.

### BRIEF DESCRIPTION OF THE FIGURES

The present method, system and device will be better understood based on the appended drawings, in which:

FIG. 1 represents a sectional view of an external surface of a railway vehicle covered with paint according to the prior art;

FIG. 2 represents a sectional view of a decoration adhesive according to the prior art with its protective films;

FIG. 3 represents a sectional view of the adhesive of FIG. 2 applied on the external surface of a railway vehicle;

FIG. 4 represents a sectional view of a decoration adhesive according to the present method, system and device with its protective films;

FIG. 5A represents a sectional view of a coating according to the present method, system and device with the adhesive of FIG. 4 applied on the external surface of a railway vehicle with its upper protective film;

FIG. 5B represents a top view of the adhesive of FIG. 5A applied on the external surface of the vehicle;

FIG. 6A represents a sectional view of the coating of FIG. 5A after the application of a paint coat outside the surface covered by the adhesive;

FIG. 6B represents a bottom view of the coating of FIG. 6A with its paint coat;

FIG. 7A represents a sectional view of the coating of FIG. 6A after removing the upper protective film of the adhesive;

FIG. 7B represents a bottom view of the coating of FIG. 7A with the printed pattern of the adhesive, and

FIG. 8 represents a sectional view of the coating of FIG. 7A after application of a protective varnish coat.

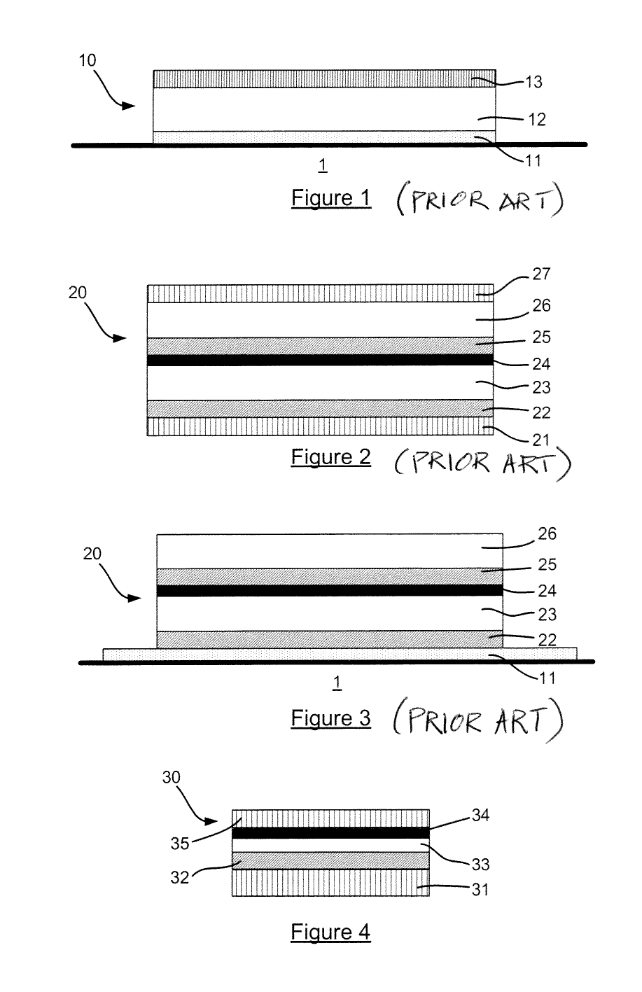

### DETAILED DESCRIPTION

With reference to FIG. 4, the coating according to the present method, system and device comprises an adhesive 30 consisting of a lower glue coat 32, a mechanical support coat 33 for the adhesive and an illustrated coat 34 comprising at least one printed pattern. The adhesive is protected by a lower protective film 31 and an upper protective film 35.

Such an adhesive 30 has the feature of having a very low thickness in operation, i.e. when the protective films 31, 35 are removed from the adhesive 30. The adhesive thickness ranges between 20 and 40 micrometres. This is achieved by modifying the thickness of the coats of the prior art adhesives so as to obtain the lowest possible mechanical posture of the adhesive while allowing it to be handled.

The prior art adhesives are conventionally used as such. To this end, they must possess a sufficient mechanical posture for being moved, folded, wound, etc., while resisting to external aggressions. Only thick adhesives are available on the market, the sum of the thicknesses of the lower glue coat, the support coat and the illustrated coat of a conventional adhesive ranging between 70 and 150 micrometres, which is too thick for being integrated into a coating.

The adhesives according to the present method, system and device have no mechanical posture function, but only a support function for the printed pattern. Thus, the adhesive has the form of a very thin film, with a thickness ranging between 20 and 40 micrometres, which cannot be used as such.

The removable protective films 31, 35 of the adhesive 30 are made in paper being covered with an adhesive and having a thickness ranging between 30 and 50 micrometres. The composition of such films 31, 35 is known to those skilled in the art, their thickness being higher than the protective films of the prior art adhesives so as to provide the adhesive, when it is protected, with a better mechanical posture upon the transportation and handling thereof.

The glue coat 32 comprises acrylics and has a thickness ranging between 10 and 20 micrometres. The composition of the glue 32 is known to those skilled in the art. The glue thickness is lower than that of prior art adhesives as the glue coat 32 does not fill a final or durable fixing function as in prior art adhesives. The very thin glue coat 32 allows for a simple positioning of the adhesive, the final fixing of the adhesive being achieved by other means to be subsequently further described.

The mechanical support coat 33 for the adhesive 30 is made in PVC and has a thickness ranging between 10 and 20 micrometres. Such a support coat has a quite lower thickness than that of the prior art adhesives, as the function thereof is only to support the printed pattern of the adhesive.

As an alternative, the mechanical support coat 33 for the adhesive 30 comprises a paint film in a dry state, i.e. a solid film, with a thickness ranging between 10 and 20 micrometres. Such a support coat has a quite lower thickness than that of prior art adhesives, as the function thereof comprises, on the one hand, supporting the printed pattern of the adhesive and, on the other hand, providing an optimal compatibility between a protective coat 43 and a coloured paint coat 42 of the coating that will be described subsequently.

A paint film in a dry state, such as manufactured by CORSO MAGENTA company and known under its commercial name Peinture à Poser®, is conventionally packaged in the form of rolls. In order to form the paint film, a paint is applied on a temporary support, and then dried. Preferably, the paint to be used is of the same nature as that of the coloured paint coat 42 that will be described subsequently. Otherwise stated, the paints of the support coat 33 and the paint coat 42 have similar properties and are compatible one with the other, allowing them to be brought into contact. The dried film of paint is preferably printed so as to comprise a decorative pattern, for example, through printing a digital picture, on a surface that could be either planar or in relief.

The dried film is afterwards glued to temporary protections so as to form an adhesive. The adhesive with its paint film in a dry state is then rolled in order to form a roll improving the packaging thereof and facilitating its transport.

For using it, it is sufficient to remove the temporary protection in order to apply the adhesive on the surface to be covered. An adhesive with a support coat comprising a paint film in a dry state has the advantage that it does not flow, thereby limiting the risk of staining. Moreover, the paint film in a dry state does not advantageously comprise any volatile organic compound (COV), which is environment-friendly. Finally, a paint based support coat 33 allows the compatibility to be enhanced with the varnish coat 43 and the paint coat 42 applied on the external surface of the vehicle outside the surface covered by the adhesive.

The illustrated coat 34 of the adhesive 30 is made by screen printing or with printing ink and has a thickness ranging between 5 and 15 micrometres. Such a coat 34 is achieved through a method for printing a digital picture (ink jet, laser, electrography, etc.) providing a wide freedom in designing the printed pattern, both in terms of colours, shapes, patterns as well as of textures. It is obvious that other printing methods could also be appropriate, for example, screen printing, offset, etc.

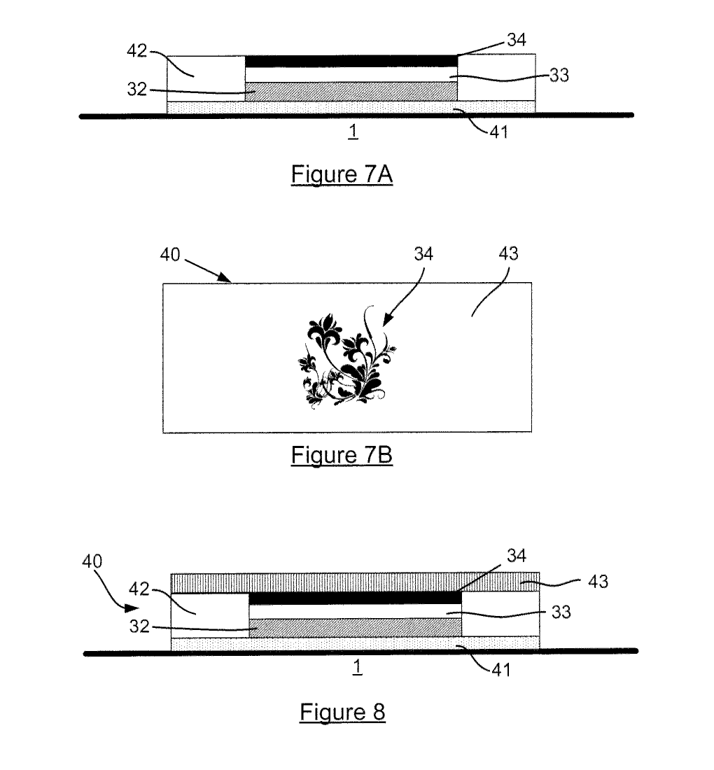

By way of an example, the illustrated coat 34 comprises a pattern of a flower with different colours, the pattern being shown only in black on FIG. 7B.

The adhesive 30 could advantageously comprise recesses so that the surface onto which the adhesive is applied is visible, here the paint undercoat.

The decorative adhesive 30 is integrated into the coating for the external surface of a transport vehicle according to the present method, system and device as shown on FIG. 8.

Before any decoration of the vehicle, its external surface could be covered with an anti-corrosion coat so as to protect it. It is obvious that other treatments could be applied on the external surface of the vehicle.

With reference to FIG. 8, the coating 40 comprises a paint undercoat 41, or primer, applied on the external surface of the vehicle, the decorative adhesive 30 being applied on the paint undercoat 41. When the adhesive 30 comprises recesses, the paint undercoat 41 is visible through said recesses. In the coating 40, the adhesive 30 is naked and does not comprise any protective films 31, 35.

The coating 40 also comprises a coloured paint coat 42 applied on said undercoat 41 outside the surface covered with the adhesive 30, the external surfaces of the paint coat 42 and the adhesive 30 being continuous. Thus, there is no relief on the surface of the coating 40, the adhesive 30 being integrated into the paint coat 42, which allows to preclude its side movement in the coating 40. In the present case, the coloured paint coat 42 and the adhesive 30 have the same thickness ranging between 20 and 40 micrometres.

The coating 40 further comprises a protective coat, here a varnish coat 43 applied on the continuous external surfaces of the paint coat 42 and the adhesive 30. The varnish 43 has a thickness ranging between 40 and 60 micrometres, the main function of which is to protect the paint coat 42 and the adhesive 30 against external aggressions such as rain, hail or, in another field, graffiti. The coating 40 according to the present method, system and device enables to integrate the adhesive 30 into the paint coat 42 due to the low thickness of the adhesive 30.

Although the adhesive 30 has a glue coat 32 and a support coat 33 with a small thickness, this is not prejudicial to the coating 40 of the present method, system and device since the adhesive 30 is laterally held by the paint coat 42 and vertically protected by the varnish coat 43. The vertical and horizontal moves of the adhesive 30 are thus precluded. The mechanical posture of the adhesive 30 is never biased, since the latter is protected as well horizontally as vertically.

The coating 40 has a low thickness ranging between 25 and 60 micrometres, which corresponds to the thickness of a conventional paint base coating. Thus, the coating has a low mass, which is advantageous.

A decorative coating 40 is obtained, having:

a long life duration being comparable to that of coatings made of paint, the adhesive 30 being totally protected;

an aesthetic appearance, the patterns being of free creation, the transport vehicle being able to be decorated with logos or digital photos, and

a quality finish, the coating surface being perfectly smooth, free of discontinuities, which is pleasant as well to see as to touch.

Preferably, the paint of the paint film in a dry state is of the same nature as the paint of the paint coat 42 applied outside the surface being covered by the adhesive 30, for example, an epoxy or polyurethane based paint. Preferably, the same type de paint pigments is used, which enables to make totally consistent the support coat 33 with, on the one hand, the varnish coat 43 and, on the other hand, the paint coat 42. Indeed, the paint of the paint coat 42 is selected to be consistent with the varnish 43. To provide for the compatibility of the adhesive 30, there is used as an adhesive support coat a paint film made from a paint having the same properties as those of the paint coat 42. Thanks to a better compatibility, the thus made coating has a better wearing and ageing resistance.

The present disclosure also relates to a method for decorating a transport vehicle, wherein:

a paint undercoat 41 is applied on the external surface 1 of the vehicle, such step being performed by means of a painting spray gun:

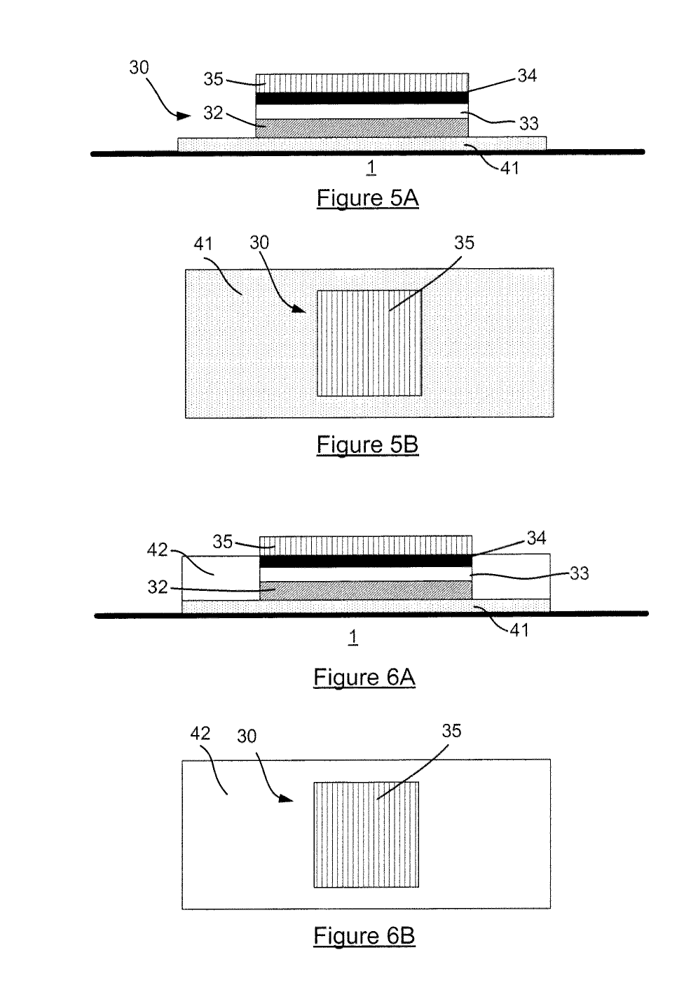

the lower protective film 31 of the adhesive 30 is removed and the sticky surface 32 of the adhesive 30 is applied on the undercoat 41 as represented on FIGS. 5A and 5B, the adhesive 30 being still covered with its upper protective film 35;

a coloured paint coat 42 is applied on said undercoat 41 outside the surface covered with the adhesive 30, the upper protective film 35 of the adhesive 30 protecting the decorative pattern 34 against potential burrs upon the application of the paint coat 42;

the paint is applied so that the external surfaces of the paint coat 42 and the adhesive 30 are continuous,

the upper protective film 35 of the adhesive 30 is removed so as to reveal the pattern of the adhesive 30, and

a protective coat, here a varnish coat 43 is applied on the continuous external surfaces of the paint coat 42 and the adhesive 30.

It is within the scope of the present method, system and device that the adhesive 30 and the paint coat 42 could be directly applied on the external surface of the vehicle, with no previous application of a paint undercoat 41.

A method has been described, wherein the application of the adhesive 30 is made before the application of the paint, the paint coat 42 being applied around the adhesive 30. It goes without saying that the application of the paint 42 could be made before the application of the adhesive 30, free-standing spaces being then arranged in the paint coat 42 to receive said adhesive 30. The free-standing spaces enable advantageously to make easier the positioning of the adhesive, the latter being applied with accuracy due to the guiding performed by the free-standing space walls.

Advantageously, such decoration method can be implemented successively on a single external surface of a transport vehicle with no need to remove the whole coating 40.

Indeed, when it is desired to modify the decoration pattern, if the latter is worn out or out of date, it suffices to <<sand>> the varnish coat 43 with a known sanding or pickling method so as to get a reduced coating thickness being lower than that of a coating with the varnish coat thereof, and the external surface of which is smooth. Preferably, between 50% and 100% of the varnish thickness are removed. It is said that the varnish is stripped.

On the sanded external surface of the old coating, a new adhesive and a new paint coat are applied in accordance with the present method, system and device and the continuous external surfaces of the new paint coat and the new adhesive are covered with a new varnish coat. Preferably, a paint undercoat can be again applied on the polished external surface of the old coating.

Thus, there is obtained a new quality coating, with no need of a long cleaning method being difficult to be implemented and requiring the use of toxic products.

It is within the scope of the present method, system and device that the decoration renewal method also could be implemented with no previous pickling, directly on the varnish coat of the old coating.

The present method, system and device have been described for a railway vehicle, but it is contemplated that the present method, system and device are also applicable to any vehicle by see, road or air.

1. A decorative coating intended to be applied on an external surface of a transport vehicle, comprising:
a decorative adhesive successively consisting of a lower glue coat, a mechanical support coat for the adhesive and an illustrated coat comprising at least one printed pattern, the adhesive being applied on the external surface of the vehicle;
a coloured paint coat applied on the external surface of the vehicle outside the surface covered by the adhesive, the external surfaces of the paint coat and the adhesive being continuous, and
a protective coat (43) applied on the continuous external surfaces of the paint coat and the adhesive.

2. The coating according to claim 1, wherein the adhesive has a thickness ranging between 20 and 40 micrometers.

3. The coating according to claim 1, wherein the protective coat is a varnish coat.

4. The coating according to claim 1, wherein a paint undercoat is applied between the external surface of the vehicle and the decorative adhesive and between the external surface of the vehicle and the pain coat.

5. The coating according to claim 1, wherein the mechanical support coat for the adhesive comprises a paint film in a dry state.

6. The coating according to claim 5, wherein the paint film in a dry state is formed from a paint having the same properties as the paint of the coloured paint coat.

7. A method for decorating an external surface of a transport vehicle, wherein:
a coloured paint coat is applied on said external surface of the vehicle and free-standing spaces are arranged in the paint coat to receive a decorative adhesive,
a decorative adhesive is applied on the external surface of the vehicle in the free-standing spaces arranged in the paint coat, the adhesive successively consisting of a lower glue coat, a mechanical support coat for the adhesive and an illustrated coat comprising at least one printed pattern; the external surfaces of the paint coat and the adhesive being continuous; and
a protective coat is applied on the continuous external surfaces of the paint coat and the adhesive.

8. The method according to claim 7, wherein a paint undercoat is applied on the external surface of the vehicle before the application of the paint coat and the adhesive.

9. The method according to claim 7 for replacing an old coating with an new coating, wherein:
the protective coat of the old coating is partially or completely removed, the thickness of the old coating being constant after removal,
a new decorative adhesive is applied on the external surface of the old coating, the adhesive successively consisting of a lower glue coat, a mechanical support coat for the adhesive and an illustrated coat comprising at least one new printed pattern;
a new coloured paint coat is applied on said external surface of the old coating outside the surface covered by the new adhesive, the external surfaces of the new paint coat and the new adhesive being continuous, and
a new protective coat is applied on the continuous external surfaces of the new paint coat and the new adhesive.
